(19) United States
(12) Patent Application Publication
(10) Pub. No.: US 2014/0123040 A1
(43) Pub. Date: May 1, 2014

(54) INFORMATION PROCESSING APPARATUS, METHOD, AND PROGRAM

(71) Applicant: Sony Corporation, Tokyo (JP)

(72) Inventors: Kenji Tanaka, Kanagawa (JP); Yoshihiro Takahashi, Kanagawa (JP); Kazumasa Tanaka, Kanagawa (JP); Michiro Hirai, Kanagawa (JP)

(73) Assignee: Sony Corporation, Tokyo (JP)

(21) Appl. No.: 14/057,533

(22) Filed: Oct. 18, 2013

(30) Foreign Application Priority Data
Oct. 25, 2012 (JP) 2012-235588

(51) Int. Cl. G06F 3/048

(52) U.S. Cl. CPC G06F 3/048
USPC 715/762

(57) ABSTRACT

There is provided an information processing apparatus including a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated, and a display control unit configured to control displaying of graphical user interfaces (GUIs) representing pieces of content located at a predetermined interval among the pieces of content classified by the classification unit.

### CROSS REFERENCE TO RELATED APPLICATIONS

This application claims the benefit of Japanese Priority Patent Application JP 2012-235588 filed Oct. 25, 2012, the entire contents of which are incorporated herein by reference.

### BACKGROUND

The present disclosure relates to an information processing apparatus, a method for the same, and a program, and particularly relates to an information processing apparatus, a method for the same, and a program which make it possible to quickly reach target content from numerous pieces of content.

A device is described in JP 2012-18686A, the device being configured to dynamically define a service executed in accordance with a search query. However, the technology described in JP 2012-18686A uses the search query.

In contrast, JP 2010-182165A describes an information analysis system configured to classify sentences of a document according to the content of the document itself and to provide a document group obtained as a result of the classification, the document group having meaning clear to a user.

### SUMMARY

However, in the technology described in JP 2010-182165A, only text information is used for the classification, and only sentences are classified.

Under these circumstances, it is desirable to quickly reach target content among many contents.

According to an embodiment of the present disclosure, there is provided an information processing apparatus including a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated, and a display control unit configured to control displaying of graphical user interfaces (GUIs) representing pieces of content located at a predetermined interval among the pieces of content classified by the classification unit.

The information processing apparatus may further include a selection unit configured to select one of the graphical user interfaces the displaying of which is controlled by the display control unit. The display control unit may control displaying of graphical user interfaces representing pieces of content located at a narrower interval than the predetermined interval, with the content represented by the graphical user interface selected by the selection unit being located in a center.

When a sum of the distances indicating the similarity between each of the two extracted pieces of content and the neighboring pieces of content is smaller, the classification unit may swap the two extracted pieces of content.

When the sum of the distances indicating the similarity between each of the two extracted pieces of content and the neighboring pieces of content is not smaller, the classification unit may return the two extracted pieces of content to original locations.

The classification unit may repeat the actions of extracting the two pieces of content and swapping the two extracted pieces of content until a value obtained by adding distances of all pieces of content becomes equal to or smaller than a predetermined value, the distances indicating similarity between each piece of content and neighboring pieces of content which are located around each piece of content.

The classification unit may repeat the actions of extracting the two pieces of content and swapping the two extracted pieces of content until a number of repetition times reaches a predetermined number of times.

The distances indicating the similarity between each of the two pieces of content and the neighboring pieces of content may be obtained from text information.

The distances indicating the similarity between each of the two pieces of content and the neighboring pieces of content may be obtained from an image feature amount or an audio feature amount.

According to an embodiment of the present disclosure, there is provided an information processing method including classifying, by an information processing apparatus, pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated, and controlling, by the information processing apparatus, displaying of graphical user interfaces (GUIs) representing pieces of content located at a predetermined interval among the classified pieces of content.

According to an embodiment of the present disclosure, there is provided a program causing a computer to function as a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated, and a display control unit configured to control displaying of graphical user interfaces (GUIs) representing pieces of content located at a predetermined interval among the pieces of content classified by the classification unit.

In one embodiment of the present disclosure, the pieces of content are arranged in the multi-dimensional space, actions of extracting two of the pieces of content and swapping the two pieces of content based on the distances indicating similarity between each of the two pieces of content and neighboring pieces of content which are located around the two pieces of content are repeated, and thereby the pieces of content are classified. Then, the displaying of the GUIs (Graphical User Interfaces) is controlled, the GUIs representing the pieces of content located at the predetermined intervals among the classified pieces of content.

According to the embodiment of the present disclosure, it is possible to quickly reach target content among numerous pieces of content.

### BRIEF DESCRIPTION OF THE DRAWINGS

FIG. 1 is a diagram illustrating a configuration example of an information processing system to which an embodiment of the present technology is applied;

FIG. 2 is a block diagram illustrating a configuration example of an information processing apparatus;

FIG. 3 is a block diagram illustrating a functional configuration example of the information processing apparatus;

FIG. 4 is a diagram illustrating facet grouping using text;

FIG. 5 is a diagram illustrating swapping between pieces of content;

FIG. 6 is a diagram illustrating an example of similar content distribution;

FIG. 7 is a diagram illustrating an example of a content selection pane;

FIG. 8 is a diagram illustrating an example of the content selection pane in the case of selecting content;

FIG. 9 is a flowchart for explaining content registration processing;

FIG. 10 is a flowchart for explaining content classification processing;

FIG. 11 is a flowchart for explaining display control processing for the content selection pane;

FIG. 12 is a diagram illustrating examples of a two-dimensional manifold to which the embodiment of the present technology is applied; and

FIG. 13 is a diagram illustrating examples of a three-dimensional manifold to which the embodiment of the present technology is applied.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

[Configuration of Information Processing System According to Embodiment of Present Technology]

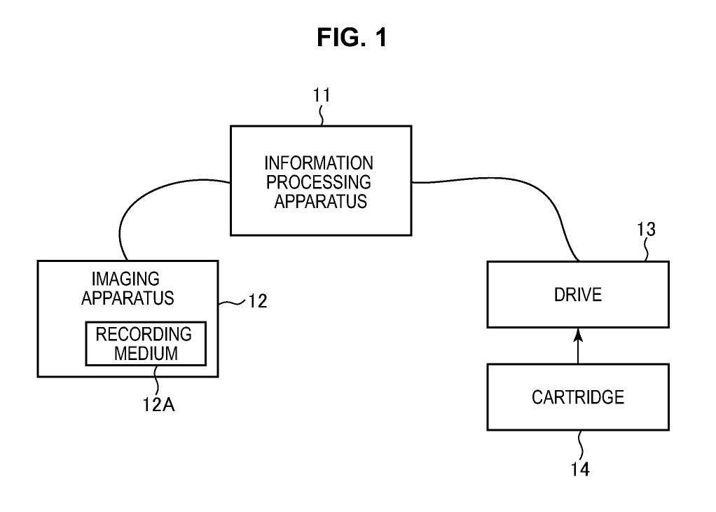

FIG. 1 is a diagram illustrating a configuration example of an information processing system to which an embodiment of the present technology is applied.

The information processing system in FIG. 1 includes an information processing apparatus 11, an imaging apparatus 12, a drive 13, and a cartridge 14.

The information processing apparatus 11 is configured of a personal computer, for example. The information processing apparatus 11 is connectable to the imaging apparatus 12 and the drive 13 through a USB (Universal Serial Bus) 3.0, for example. When being connected to the imaging apparatus 12 and the drive 13, the information processing apparatus 11 writes one or more pieces of content stored in a recording medium 12A of the connected imaging apparatus 12 to the cartridge 14 loaded on the drive 13, in accordance with the user's manipulation.

The information processing apparatus 11 archives the pieces of content written to the cartridge 14, stores feature amounts extracted from the pieces of content, and classifies the archived pieces of content by using the feature amounts. Note that a description is given below by referring to the classification also as grouping. Then, the information processing apparatus 11 displays a selection pane including the classified pieces of content to cause the user to select one of the pieces of content, whereby the user can quickly reach desired content.

The imaging apparatus 12 captures an image of a subject and records content of a captured image (a moving image or a still image) in the recording medium 12A. The recording medium 12A is configured of an optical disc, a memory card, or the like.

The drive 13 includes the cartridge 14 attachably and detachably loaded thereon. Under control of the connected information processing apparatus 11, the drive 13 writes content of the imaging apparatus 12 or the information processing apparatus 11 to a recording medium included in the cartridge 14 and erases the file.

The cartridge 14 is a data storage configured such that one volume includes 12 recording media. Note that the recording media are optical discs, for example. A description is given below of an example in which the cartridge 14 includes 12 optical discs. However, the recording media are not necessarily limited to the optical discs, and the number of the recording media is not limited to 12.

Note that the example in FIG. 1 shows that the file recorded in the recording medium 12A is written to the cartridge 14 loaded on the drive 13 while the imaging apparatus 12 is connected to the information processing apparatus 11. In contrast, for example, content recorded in the recording medium 12A may be written to the cartridge 14 loaded on the drive 13 while the recording medium 12A is loaded on a drive for the recording medium 12A connected to the information processing apparatus 11 through a USB.

[Configuration of Information Processing Apparatus]

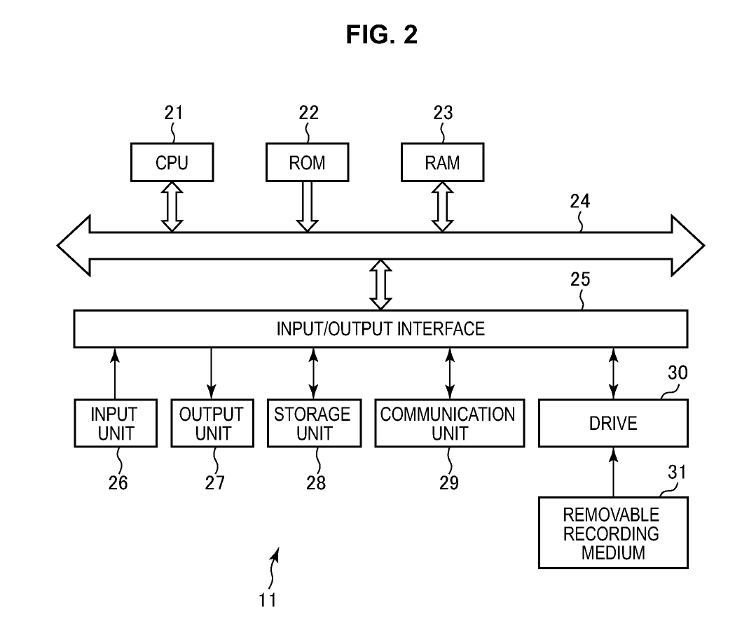

FIG. 2 is a diagram illustrating a configuration example of an information processing apparatus to which the embodiment of the present technology is applied.

In the information processing apparatus 11, a CPU (Central Processing Unit) 21, a ROM (Read Only Memory) 22, and a RAM (Random Access Memory) 23 are mutually connected through a bus 24.

An input/output interface 25 is connected to the bus 24 further. To the input/output interface 25, an input unit 26, an output unit 27, a storage unit 28, a communication unit 29, and a drive 30 are connected.

The input unit 26 is configured of a keyboard, a mouse, a microphone, and the like. The output unit 27 is configured of a display, a speaker, and the like. The storage unit 28 is configured of a hard disk, a non-volatile memory, or the like. The communication unit 29 is configured of a network interface or the like.

The drive 30 drives a removable recording medium 31 such as a magnetic disk, an optical disc, a magneto-optical disc, or a semiconductor memory to record data and delete data recorded in the removable recording medium 31.

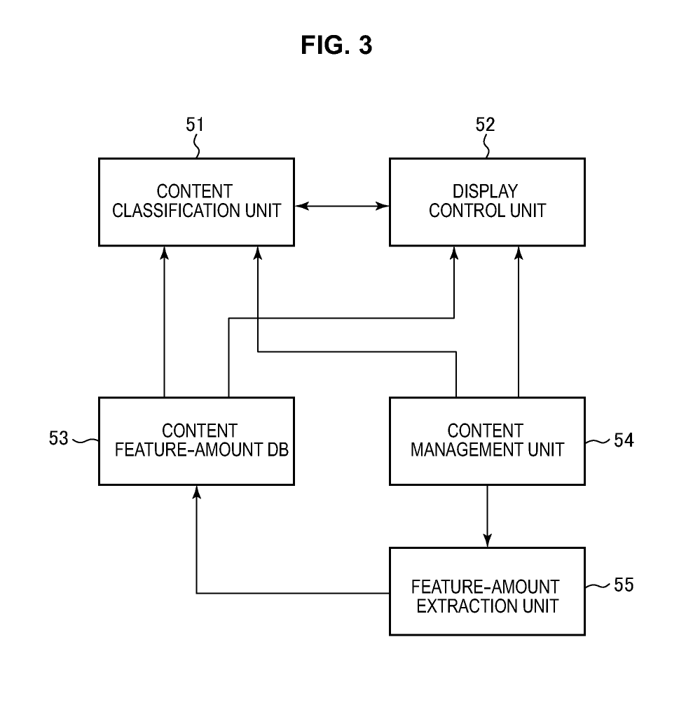

In the information processing apparatus 11 as configured above, the CPU 21 loads a program stored, for example, in the storage unit 28 on the RAM 23 through the input/output interface 25 and the bus 24, and executes the program. Thereby, functional blocks, for example, in FIG. 3 are configured, and predetermined processing is performed.

Note that the hardware configuration of the information processing apparatus 11 is not limited to the example in FIG. 2 and may be configured at least to achieve a functional configuration in FIG. 3.

[Functional Configuration Example of Information Processing Apparatus]

FIG. 3 is a block diagram illustrating a functional configuration example of the information processing apparatus.

In an example in FIG. 3, the information processing apparatus 11 includes a content classification unit 51, a display control unit 52, a content feature-amount DB (database) 53, a content management unit 54, and a feature-amount extraction unit 55.

The content classification unit 51 classifies pieces of content registered in the content management unit 54 according to a name, a file type, or the like. The content classification unit 51 causes the pieces of content registered in the content management unit 54 to be arranged in a multi-dimensional space, repeats actions of extracting two of the pieces of content and swapping the two pieces of content based on distances indicating similarity between each of the extracted pieces of content and the neighboring pieces of content which are located around the extracted content to rearrange the pieces of content, and thereby classifies the pieces of content. At this time, each distance indicating the similarity between the content and the neighboring pieces of content is obtained from text information of the pieces of content managed by the content management unit 54, metadata information, image feature amounts, or audio feature amounts of the pieces of content stored in the content feature-amount DB 53, or the like.

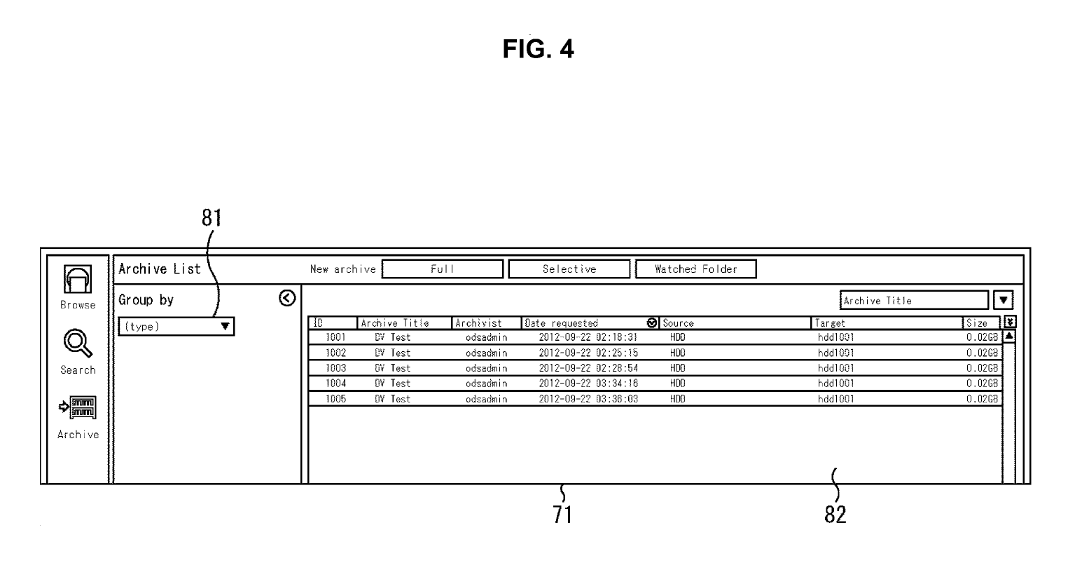

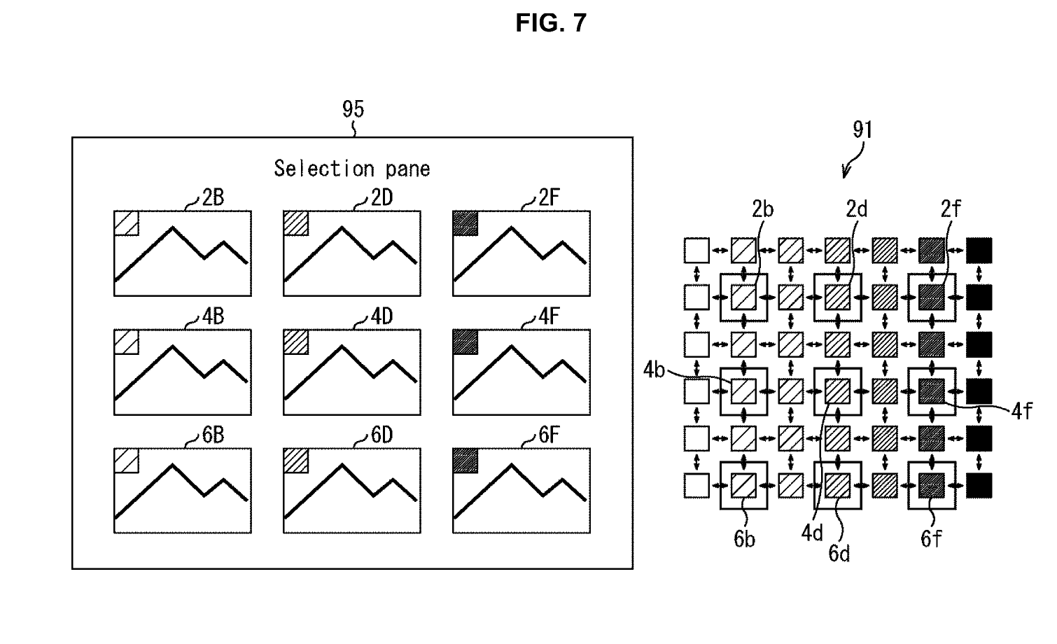

The display control unit 52 generates and displays a content-list display pane to be described later with reference to FIG. 4, a content selection pane to be described later with reference to FIG. 7, and the like on the display or the like included in the output unit 27.

In other words, the display control unit 52 generates the content selection pane including GUIs showing the pieces of content located at predetermined intervals in distribution of the pieces of content classified by the content classification unit 51, and displays the generated content selection pane on the output unit 27. When the user selects one of the GUIs showing the pieces of content by manipulating the mouse or the like included in the input unit 26 (hereinafter, simply referred to as the input unit 26), the display control unit 52 also generates a content selection pane, with the selected GUI being located in the center of the content selection pane. In generating the content selection pane, reference is appropriately made also to information on the pieces of content registered in the content management unit 54 and feature amounts of the pieces of content registered in the content feature-amount DB 53.

The content feature-amount DB 53 stores the metadata information of the pieces of content managed by the content management unit 54, the image and audio feature amounts of the pieces of content extracted by the feature-amount extraction unit 55, and the like.

The content management unit 54 registers and manages the content written to the cartridge 14.

The feature-amount extraction unit 55 extracts metadata information from the content registered in the content management unit 54 and registers the extracted information in the content feature-amount DB 53. The feature-amount extraction unit 55 also extracts various feature amounts as well as an image feature amount and an audio feature amount and registers the extracted feature amounts in the content feature-amount DB 53.

[Explanation of Facet Grouping Using Text]

In the information processing apparatus 11, pieces of content are grouped according to a name or a creation date and time as facet grouping using text, and are displayed in a content-list display pane 71 illustrated in FIG. 4.

An example in FIG. 4 shows the content-list display pane 71. A name of content, a creation date and time, or the like is selected in a drop-down box 81 below Group by in the second column from the left in the content-list display pane 71. In accordance with this, the pieces of content are grouped (classified) and displayed as a list in a list display section 82 on the right side of the content-list display pane 71.

For example, in the case of the content name, the list display section 82 displays a result of classification according to the first character of the content name. Note that, in this case, it is possible to perform grouping into A-E, F-J, K-O, and V-Z, or the like according to the first character of the content name and to see which group the content belongs to.

In the case of the creation date and time, the list display section 82 displays a result of classification in terms of “today”, “yesterday”, “recent”, “one week earlier”, “one month earlier”, “one year earlier”, or the like.

In the example in FIG. 4, type is currently selected in the drop-down box 81. In accordance with this, a list of the pieces of content is displayed in the list display section 82 on the right side, with the pieces of content grouped according to the type of the pieces of content.

Note that in the case of type, types such as mxf, mp4, avi, and mts obtained from the pieces of content are displayed in a lower portion of the drop-down box 81. By selecting a certain type among these, it is also possible to display only the pieces of content grouped according to the selected type in the list display section 82.

[Grouping According to Content (Text) of Content]

Examples of a case where content has a lot of text information include cases where the content itself is formed in a text format and where the content is a moving image content but has a lot of metadata information. In such cases, it is possible to group the content according to the content of the text.

To group the content, there is a method in which the text is divided in advance into words by using a morphological analysis, distance calculations are performed on the words by using a technique called cosine correlation or the like, and then grouping processing is performed by using the distances.

[Specific Example of Grouping Processing]

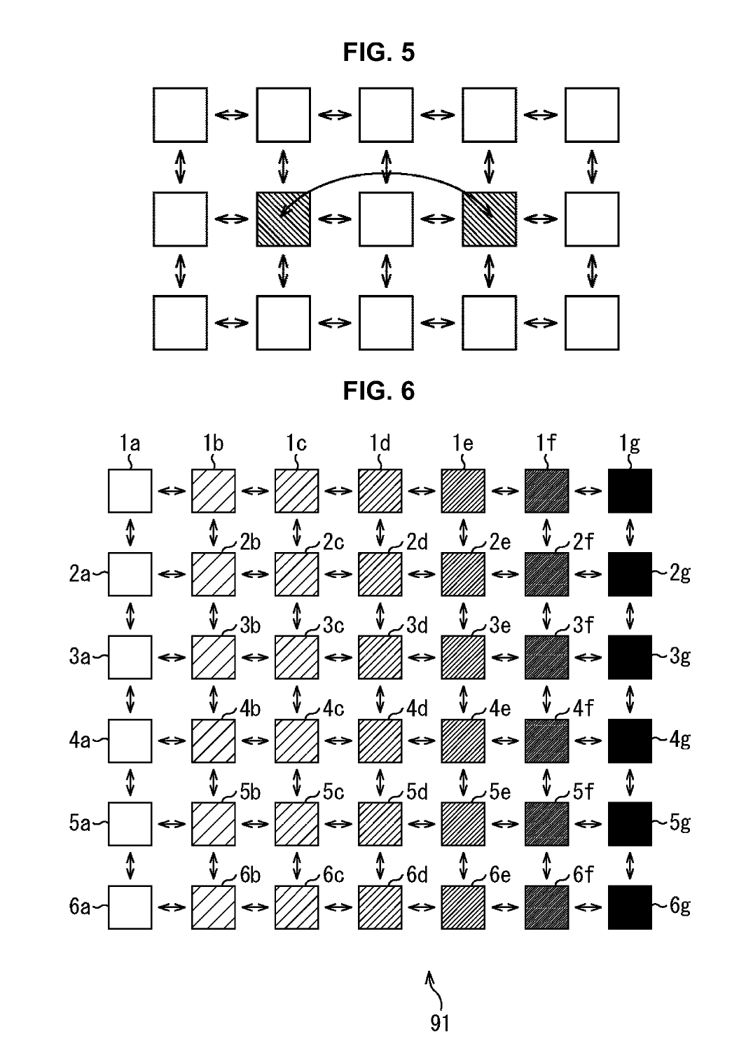

Next, the grouping processing using the aforementioned distances will be described specifically with reference to FIG. 5. In an example in FIG. 5, squares represent pieces of content.

As illustrated in FIG. 5, the content classification unit 51 arranges the pieces of content all over a two-dimensional space with in such a manner that the pieces of content are placed on lattice points of the two-dimensional space. Note that only 5×3 pieces of content are arranged in the example in FIG. 5, but actually all of the pieces of content managed by the content management unit 54 are placed on the lattice points of the two-dimensional space.

The content classification unit 51 extracts any two pieces of content (for example, hatched pieces of content) from among the pieces of content, calculates distances between each extracted piece of content and four neighboring pieces of content located around the content, and obtains a sum for each piece of content. Then, the sums are set as D_a and D_b.

The content classification unit 51 swaps the two pieces of content and calculates D_a′ and D_b′ in the similar manner.

Only in the case of D_a′+D_b′<D_a+D_b, that is, only if the swapping between the pieces of content results in a smaller sum of the distances between the two pieces of content and the neighboring pieces of content, the content classification unit 51 keeps the swapping. If not, the content classification unit 51 undoes the swapping.

The content classification unit 51 repeats the processing a predetermined number of times, or until a value obtained by adding the distances of all the pieces of content between each piece of content and the neighboring pieces of content falls below a predetermined value or an average. In this way, the content classification unit 51 groups (classifies) the pieces of content.

[Example of Content Distribution after Grouping]

FIG. 6 is a conceptual diagram of content distribution after the grouping. An example in FIG. 6 shows a two-dimensional space 91 including squares representing the pieces of content managed by the content management unit 54. In other words, in the case of FIG. 6, 7×6 pieces of content are arranged in the two-dimensional space 91, and thus the content management unit 54 manages 42 pieces of content.

Specifically, pieces of content 1a to 6a are arranged in the first column from the left; pieces of content 1b to 6b, in the second column; pieces of content 1c to 6c, in the third column; pieces of content 1d to 6d, in the fourth column; pieces of content 1e to 6e, in the fifth column; pieces of content 1f to 6f, in the sixth column; and pieces of content 1g to 6g, in the seventh column.

In the two-dimensional space 91, each piece of content is arranged in such a manner that pieces of content having high similarity to the content neighbor the content in up-down and right-left directions according to the aforementioned grouping of the pieces of content.

In other words, it can be said that from the content arrangement in the two-dimensional space 91, for example, the content 3c has high similarity to the pieces of content 2c, 3d, 4c, and 3b which neighbor the content 3c in the up-down and right-left directions. It can also be said that, for example, the content 5e has high similarity to the pieces of content 4e, 5f, 6e, and 5d which neighbor the content 5e in the up-down and right-left directions.

[Example of Content Selection Pane]

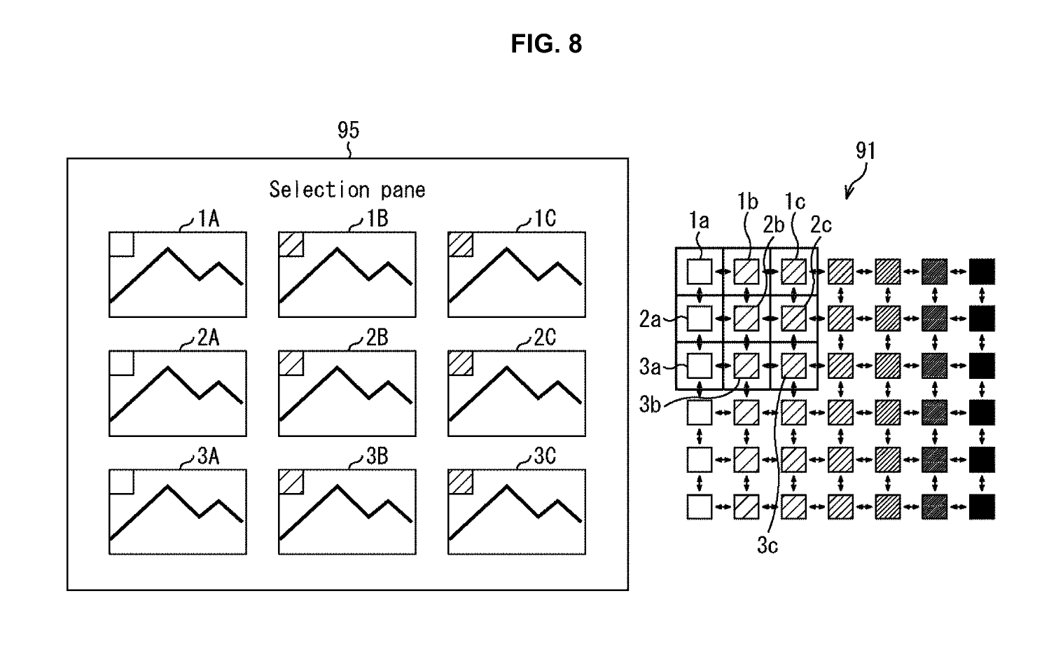

Next, a screen for user navigation in the aforementioned two-dimensional space, that is, grouped pieces of content will be described with reference to FIGS. 7 and 8.

Examples in FIGS. 7 and 8 each show a content selection pane 95 and the two-dimensional space 91 described above with reference to FIG. 6. The content selection pane 95 displays GUIs for the user to select content, the GUIs corresponding to the pieces of content surrounded by lines in the two-dimensional space 91. Note that, for example, it is possible to superpose preview images of the pieces of content on the respective GUIs.

Firstly, the display control unit 52 displays GUIs in the content selection pane 95 in FIG. 7, the GUIs corresponding to squares (pieces of content) arranged in as wide a range as possible and at as wide intervals as possible so that the whole two-dimensional space 91 can be seen.

Specifically, in the example in FIG. 7, the content selection pane 95 displays a GUI 2B corresponding to the content 2b; a GUI 4B, the content 4b; a GUI 6B, the content 6b; a GUI 2D, the content 2d; a GUI 4D, the content 4d; a GUI 6D, the content 6d; a GUI 2F, the content 2f; a GUI 4F, the content 4f; and a GUI 6F, the content 6f.

One of the GUIs in the content selection pane 95 is selected in accordance with the user manipulation inputted through the input unit 26. In response to this, the display control unit 52 causes the content selection pane 95 in FIG. 8 to display GUIs corresponding to the pieces of content located at narrower intervals than in the case in FIG. 7, with the content corresponding to the selected GUI being located in the center of the content selection pane 95.

In other words, the GUI 2B located in the upper left corner of the content selection pane 95 in FIG. 7 is selected in accordance with the user manipulation. In response to this, the display control unit 52 causes the content selection pane 95 in FIG. 8 to display GUIs corresponding to the pieces of content surrounded by the lines in the two-dimensional space 91 in FIG. 8, with the content corresponding to the selected the GUI 2B being located in the center.

Specifically, in the example in FIG. 8, the content selection pane 95 displays a GUI 1A corresponding to the content 1a; a GUI 2A, the content 2a; a GUI 3A, the content 3a; a GUI 1B, the content 1b; the GUI 2B, the content 2b; a GUI 3B, the content 3b; a GUI 1C, the content 1c; a GUI 2C, the content 2c; and a GUI 3C, the content 3c.

In other words, by displaying the content selection pane 95 in FIG. 7, it is possible to firstly navigate as wide a range of elements (pieces of content) as possible. Then, by displaying the content selection pane 95 in FIG. 8, it is possible to select content from a certain number of content options provided every time, while approaching to desired content but without limiting the content options to one.

[Grouping According to the Content (Image or Audio) of Content]

The description has been given of the example in which content includes a lot of text information. However, it is also possible to use as a distance between pieces of content various feature amounts such as an image feature amount and an audio feature amount.

As the image feature amount, it is possible to use, for example, a pixel value itself, a luminance histogram, a color histogram, a direction histogram, image activity distribution, a color having the largest region, or movement distribution in the case of a moving image.

As the audio feature amount, it is possible to use, for example, frequency distribution, a frequency at which power reaches a peak, a sound continuity pattern, and the like.

A combination of a plurality of the attributes above may be used. A combination of these feature amounts and the aforementioned text information may also be used. Distances indicating similarity between pieces of content are calculated from these feature amounts, and the calculated distances are used for the grouping processing described above with reference to FIG. 5. Then, the content selection pane described above with reference to FIGS. 7 and 8 is displayed.

[Content Registration Processing]

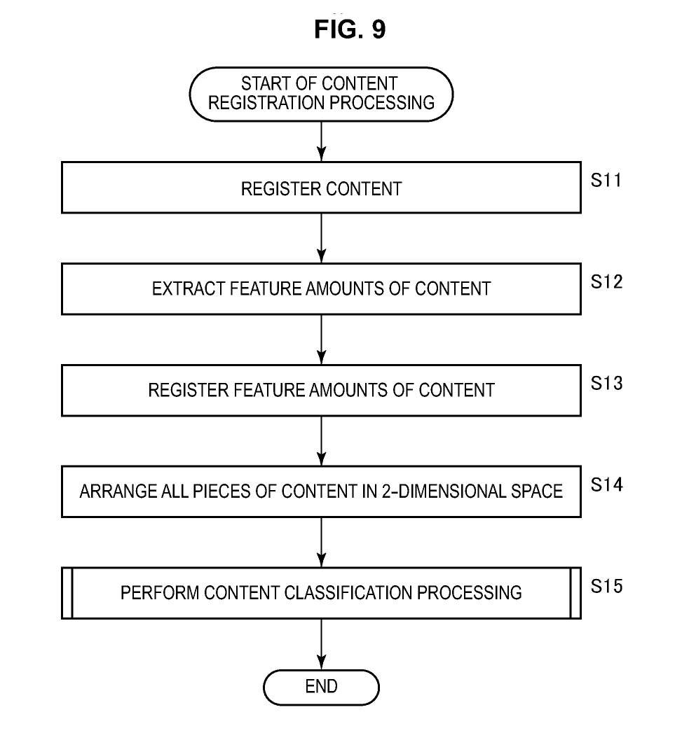

Next, content registration processing by the information processing apparatus 11 will be described with reference to a flowchart in FIG. 9.

When being connected to the imaging apparatus 12 and the drive 13, the information processing apparatus 11 writes one or more pieces of content stored in the recording medium 12A of the connected imaging apparatus 12 to the cartridge 14 loaded on the drive 13, in accordance with the user manipulation.

In Step S11, the content management unit 54 registers therein the content written to the cartridge 14.

In Step S12, the feature-amount extraction unit 55 extracts various feature amounts including metadata information, an image feature amount, and an audio feature amount from the content registered in the content management unit 54. In Step S13, the feature-amount extraction unit 55 registers the extracted metadata information and feature amounts in the content feature-amount DB 53.

In Step S14, the content classification unit 51 arranges all of the pieces of content managed by the content management unit 54 in a two-dimensional space. For example, as illustrated in FIG. 5, the content classification unit 51 arranges the pieces of content all over the two-dimensional space in such a manner that the pieces of content are placed on the lattice points.

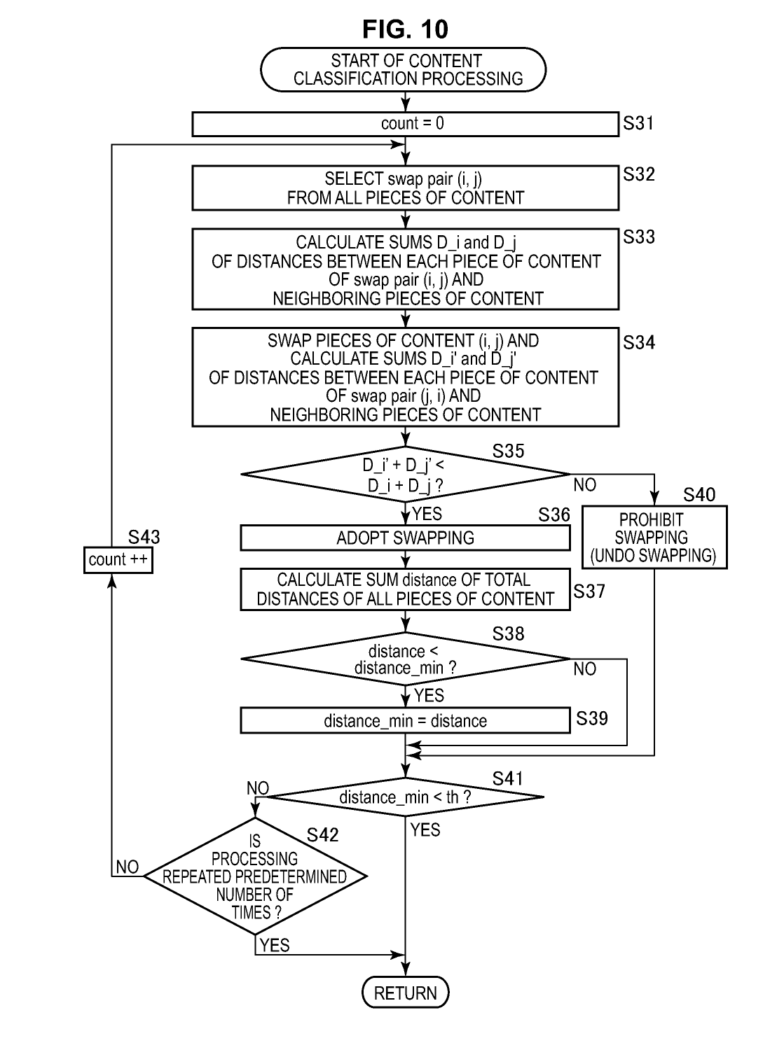

In Step S15, the content classification unit 51 performs classification processing on the pieces of content registered in the content management unit 54. The content classification processing will be described later with reference to FIG. 10. In the processing in Step S15, actions of extracting two pieces of content from the pieces of content arranged in the two-dimensional space and swapping the two pieces of content based on the distances indicating similarity between each of the two extracted pieces of content and the neighboring pieces of content are repeated to rearrange the pieces of content, and thereby the pieces of content are classified.

In this way, in the information processing apparatus 11, the pieces of content are registered, the metadata and the feature amounts are registered, all of the pieces of content are arranged in the two-dimensional space, the pieces of content are rearranged, and thereby the pieces of content are classified.

[Content Classification Processing]

Next, the content classification processing in Step S15 in FIG. 9 will be described with reference to a flowchart in FIG. 10.

In Step S31, the content classification unit 51 sets 0 as count. In Step S32, as described above with reference to FIG. 5, the content classification unit 51 selects a swap pair (i, j) which are the two pieces of content, from among all of the pieces of content arranged in the two-dimensional space.

In Step S33, the content classification unit 51 calculates sums D_i and D_j each of which is a sum of distances between the corresponding content in the swap pair (i, j) and the neighboring pieces of content.

In Step S34, the content classification unit 51 swaps the pieces of content (i, j) and calculates sums D_i′ and D_j′ each of which is a sum of distances between the corresponding content in a swap pair (j, i) and the neighboring pieces of content.

In Step S35, the content classification unit 51 judges where or not D_i′+D_j′<D_i+D_j holds true. If it is judged in Step S35 that D_i′+D_j′<D_i+D_j holds true, the processing proceeds to Step S36.

The content classification unit 51 employs the swapping between the pieces of content (i, j) in Step S36, and calculates distance which is a total sum of distances between every content and the pieces of content neighboring the content in Step S37.

In Step S38, the content classification unit 51 judges whether or not distance calculated in Step S37<distance_min holds true. If it is judged in Step S38 that distance<distance_min holds true, the processing proceeds to Step S39. In Step S39, the content classification unit 51 sets distance_min=distance, and the processing proceeds to Step S41.

If it is judged in Step S38 that distance<distance_min does not hold true, Step S39 is skipped, and the processing proceeds to Step S41.

If it is judged in Step S35 that D_i′+D_j′<D_i+D_j does not hold true, the processing proceeds to Step S40. In Step S40, the content classification unit 51 prohibits the swapping between the pieces of content (i, j) and undoes the swapping, and the processing proceeds to Step S41.

In Step S41, the content classification unit 51 judges whether or not distance_min<a predetermined value th holds true. Note that the predetermined value may be an average value. If it is judged in Step S41 that distance_min<the predetermined value th holds true, the content classification processing is terminated.

If it is judged in Step S41 that distance_min<the predetermined value th does not hold true, the processing proceeds to Step S42. In Step S42, the content classification unit 51 refers to a value of count to judge whether or not the processing is repeated a predetermined number of times. If it is judged in Step S42 that the processing is repeated the predetermined number of times, the content classification processing is terminated.

If it is judged in Step S42 that the processing has not been repeated the predetermined number of times, the processing proceeds to Step S43. In Step S43, the content classification unit 51 increments count by 1. Then, the processing moves back to Step S32, and subsequent steps are repeated.

In this way, the pieces of content are arranged in the two-dimensional space 91 as described above with reference to FIG. 6, and thereby the pieces of content are classified.

[Display Control Processing]

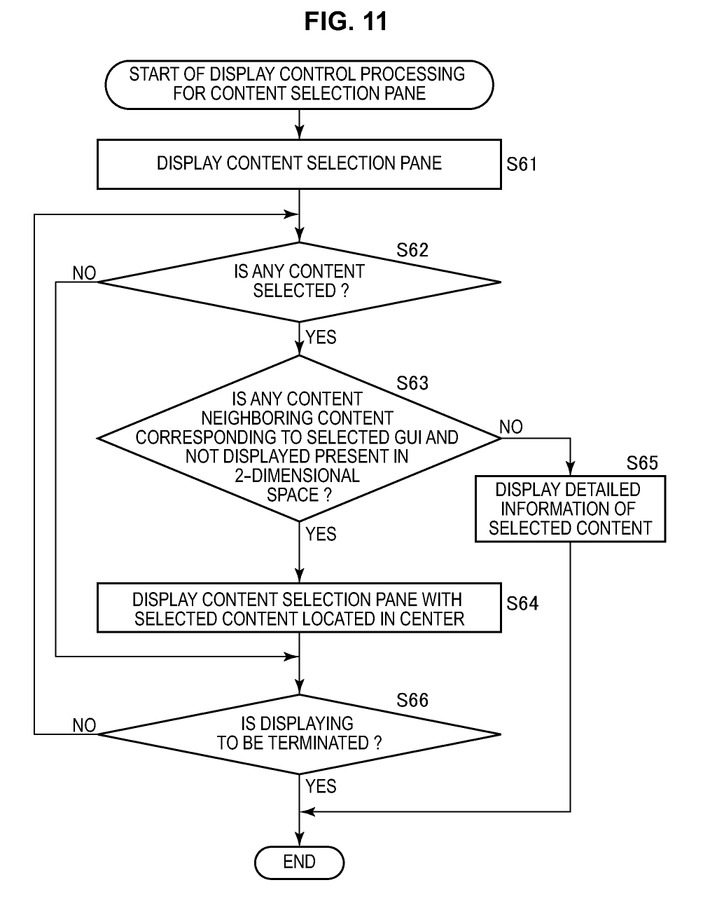

Next, display control processing for the content selection pane by the information processing apparatus 11 will be described with reference to a flowchart in FIG. 11.

In Step S61, the display control unit 52 displays the content selection pane 95 described above with reference to FIG. 7. In the content selection pane 95 in FIG. 7, the GUIs corresponding to the pieces of content (squares) arranged in as wide a range as possible and at as wide intervals as possible are displayed so that the whole two-dimensional space 91 can be seen.

In Step S62, the display control unit 52 judges whether or not any of the pieces of content corresponding to the GUIs is selected in accordance with the user manipulation. If it is judged in Step S62 that one of the pieces of content corresponding to the GUIs is selected, the processing proceeds to Step S63.

In Step S63, in response to the user manipulation inputted through the input unit 26, the display control unit 52 judges whether or not any content which neighbors the content corresponding to the selected GUI in the two-dimensional space and which is not displayed in the content selection pane 95 is present in the two-dimensional space.

For example, when the GUI 2B is selected in the content selection pane 95 in FIG. 7, pieces of content which neighbor the content 2b corresponding to the GUI 2B and which are not displayed are present in the two-dimensional space. Accordingly, in this case, it is judged in Step S63 that the content not displayed is present, and the processing proceeds to Step S64.

In Step S64, the display control unit 52 displays the content selection pane 95 including the selected content 2b located in the center. At this time, the display control unit 52 displays, in the content selection pane 95 in FIG. 8, GUIs representing pieces of content located at narrower intervals than in the case in FIG. 7, with the content corresponding to the selected GUI being located in the center. Thereafter, the processing proceeds to Step S66.

Note that, for example, when the GUI 2C is selected in the content selection pane 95 in FIG. 8, the pieces of content (1d, 2d, and 3d) which neighbor the content 2c corresponding to the GUI 2C and which are not displayed in the content selection pane 95 are still present in the two-dimensional space. Also in this case, the content selection pane 95 is displayed, with the content 2c being located in the center. However, in this case, the GUIs representing the pieces of content located at the same intervals as in the case in FIG. 8 are displayed.

On the other hand, for example, when the GUI 2B in the content selection pane 95 in FIG. 8 is selected, any content which neighbors the content 2b corresponding to the GUI 2B and which is not displayed in the content selection pane 95 is not present in the two-dimensional space. Accordingly, in this case, it is judged in Step S63 that the content not displayed is not present, and the processing proceeds to Step S65.

In Step S65, the display control unit 52 displays detailed information or the like of the selected content, and the display control processing for the content selection pane is terminated.

In addition, if it is judged in Step S62 that the content is not selected, the processing proceeds to Step S66.

In Step S66, the display control unit 52 judges whether or not to terminate the displaying of the content selection pane. If it is judged in Step S66 that the displaying of the content selection pane is to be terminated, the display control processing for the content selection pane is terminated.

If it is judged in Step S66 that the displaying of the content selection pane is not to be terminated, the processing moves back to Step S62, and subsequent steps are repeated.

As described above, the pieces of content are arranged in the two-dimensional space, swapping is repeated only when the sum of the distances from the neighboring pieces of content indicating similarity becomes smaller, and thereby the pieces of content are classified. Thus, it is possible to efficiently classify numerous pieces of content (items).

In addition, the content selection pane is displayed which displays the GUIs for selection from the pieces of content arranged in as wide a range as possible and at as wide intervals as possible in the two-dimensional space. Thus, it is possible to firstly navigate as wide a range of elements (pieces of content) as possible.

Further, the content selection pane is displayed which includes the GUIs for the pieces of content in the two-dimensional space, with the content corresponding to the selected GUI being located in the center. This makes it possible to select one of the pieces of content from a certain number of content options provided every time, while approaching to desired content but without limiting the content options to one.

Note that any of the pieces of content described above may be text, a moving image, a still image, and audio.

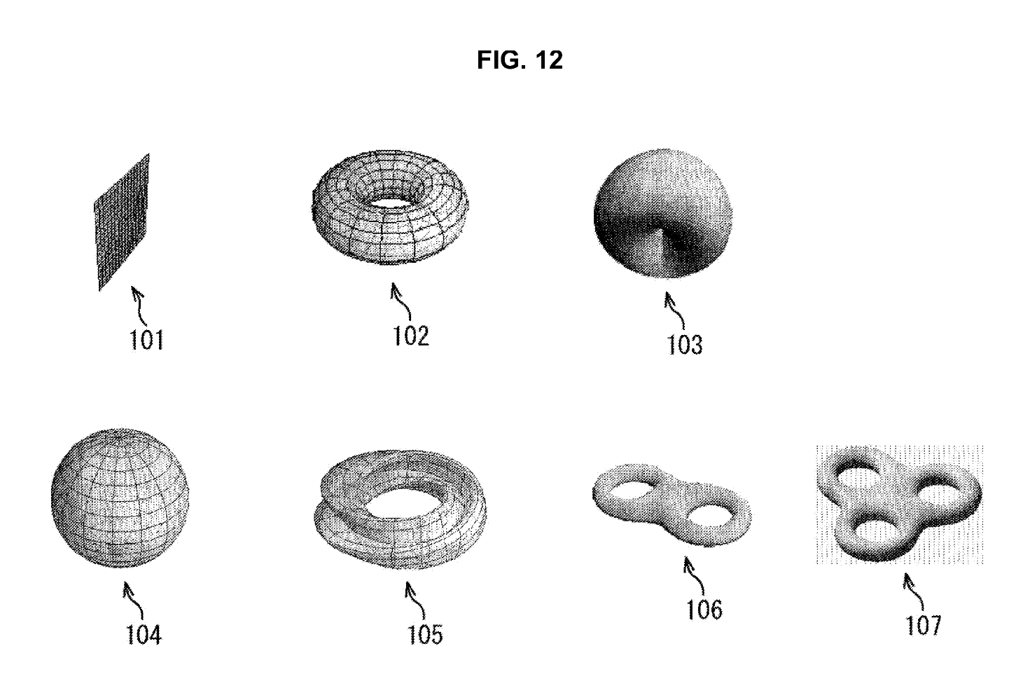

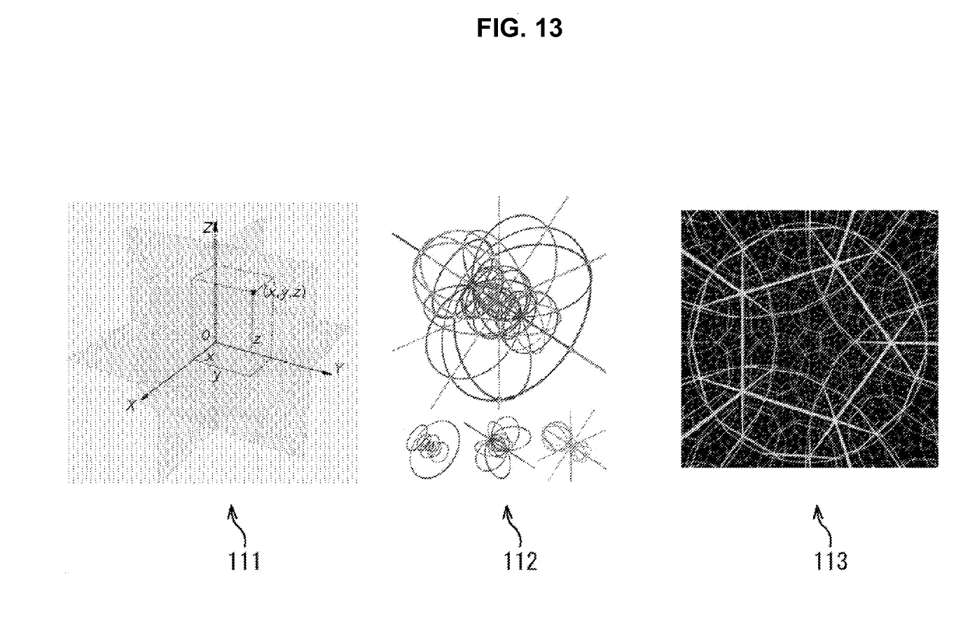

Note that the example in which the pieces of content are arranged in the two-dimensional space has been described, but the embodiment of the present technology is not limited to only the two-dimensional space. The embodiment of the present technology is applicable to not only the two dimensions but also other multiple dimensions. For example, the embodiment of the present technology is applicable to two-dimensional manifolds as illustrated in FIG. 12 and three-dimensional manifolds as illustrated in FIG. 13.

[Modification]

FIG. 12 is a diagram illustrating examples of the two-dimensional manifold to which the embodiment of the present technology is applicable, and FIG. 13 is a diagram illustrating examples of the three-dimensional manifold to which the embodiment of the present technology is applicable.

The example described above is an example in which pieces of content are arranged on a two-dimensional plane 101 which is one of the two-dimensional manifolds, but the embodiment of the present technology is not limited thereto. In other words, the pieces of content may be arranged on a torus 102, an intersection plane 103, a sphere 104, a Klein bottle 105, a double torus 106, or a triple torus 107 which is one of the two-dimensional manifolds.

In addition, the pieces of content may be arranged on Euclidean coordinates 111, a 3-sphere 112, or a Hyperbolic3-space 113 which is one of the three-dimensional manifolds.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

In this case, as one example, the program executed by the computer (the CPU 21) in FIG. 2 may be provided by being recorded on the removable recording medium 31 as a packaged medium or the like. The program can also be provided via a wired or wireless transfer medium, such as a local area network, the Internet, or a digital satellite broadcast.

In the computer, by loading the removable recording medium 31 into the drive 30, the program can be installed into the storage unit 28 via the input/output interface 25. It is also possible to receive the program from a wired or wireless transfer medium using the communication unit 29 and install the program into the storage unit 28. As another alternative, the program can be installed in advance into the ROM 22 or the storage unit 28.

It should be noted that the program executed by a computer may be a program that is processed in time series according to the sequence described in this specification or a program that is processed in parallel or at necessary timing such as upon calling.

In the present disclosure, steps of describing the above series of processes may include processing performed in time-series according to the description order and processing not processed in time-series but performed in parallel or individually.

The embodiment of the present disclosure is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present technology can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same. In other words, an embodiment of the disclosure is not limited to the embodiments described above, and various changes and modifications may be made without departing from the scope of the disclosure.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and

a display control unit configured to control displaying of graphical user interfaces (GUIs) representing pieces of content located at a predetermined interval among the pieces of content classified by the classification unit.

(2) The information processing apparatus according to (1), further including:

a selection unit configured to select one of the graphical user interfaces the displaying of which is controlled by the display control unit,

wherein the display control unit controls displaying of graphical user interfaces representing pieces of content located at a narrower interval than the predetermined interval, with the content represented by the graphical user interface selected by the selection unit being located in a center.

(3) The information processing apparatus according to (1) or (2),

wherein when a sum of the distances indicating the similarity between each of the two extracted pieces of content and the neighboring pieces of content is smaller, the classification unit swaps the two extracted pieces of content.

(4) The information processing apparatus according to any one of (1) to (3),

wherein when the sum of the distances indicating the similarity between each of the two extracted pieces of content and the neighboring pieces of content is not smaller, the classification unit returns the two extracted pieces of content to original locations.

(5) The information processing apparatus according to any one of (1) to (4),

wherein the classification unit repeats the actions of extracting the two pieces of content and swapping the two extracted pieces of content until a value obtained by adding distances of all pieces of content becomes equal to or smaller than a predetermined value, the distances indicating similarity between each piece of content and neighboring pieces of content which are located around each piece of content.

(6) The information processing apparatus according to any one of (1) to (4),

wherein the classification unit repeats the actions of extracting the two pieces of content and swapping the two extracted pieces of content until a number of repetition times reaches a predetermined number of times.

(7) The information processing apparatus according to any one of (1) to (6),

wherein the distances indicating the similarity between each of the two pieces of content and the neighboring pieces of content are obtained from text information.

(8) The information processing apparatus according to any one of (1) to (6),

wherein the distances indicating the similarity between each of the two pieces of content and the neighboring pieces of content are obtained from an image feature amount or an audio feature amount.

(9) An information processing method including:

classifying, by an information processing apparatus, pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and

controlling, by the information processing apparatus, displaying of graphical user interfaces (GUIs) representing pieces of content located at a predetermined interval among the classified pieces of content.

(10) A program causing a computer to function as:

a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and

a display control unit configured to control displaying of graphical user interfaces (GUIs) representing pieces of content located at a predetermined interval among the pieces of content classified by the classification unit.

What is claimed is:

1. An information processing apparatus comprising:
a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and
a display control unit configured to control displaying of graphical user interfaces (GUIs) representing pieces of content located at a predetermined interval among the pieces of content classified by the classification unit.

2. The information processing apparatus according to claim 1, further comprising:
a selection unit configured to select one of the graphical user interfaces the displaying of which is controlled by the display control unit,
wherein the display control unit controls displaying of graphical user interfaces representing pieces of content located at a narrower interval than the predetermined interval, with the content represented by the graphical user interface selected by the selection unit being located in a center.

3. The information processing apparatus according to claim 1,
wherein when a sum of the distances indicating the similarity between each of the two extracted pieces of content and the neighboring pieces of content is smaller, the classification unit swaps the two extracted pieces of content.

4. The information processing apparatus according to claim 3,
wherein when the sum of the distances indicating the similarity between each of the two extracted pieces of content and the neighboring pieces of content is not smaller, the classification unit returns the two extracted pieces of content to original locations.

5. The information processing apparatus according to claim 4,
wherein the classification unit repeats the actions of extracting the two pieces of content and swapping the two extracted pieces of content until a value obtained by adding distances of all pieces of content becomes equal to or smaller than a predetermined value, the distances indicating similarity between each piece of content and neighboring pieces of content which are located around each piece of content.

6. The information processing apparatus according to claim 4,
wherein the classification unit repeats the actions of extracting the two pieces of content and swapping the two extracted pieces of content until a number of repetition times reaches a predetermined number of times.

7. The information processing apparatus according to claim 1,
wherein the distances indicating the similarity between each of the two pieces of content and the neighboring pieces of content are obtained from text information.

8. The information processing apparatus according to claim 1,
wherein the distances indicating the similarity between each of the two pieces of content and the neighboring pieces of content are obtained from an image feature amount or an audio feature amount.

9. An information processing method comprising:
classifying, by an information processing apparatus, pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and
controlling, by the information processing apparatus, displaying of graphical user interfaces (GUIs) representing pieces of content located at a predetermined interval among the classified pieces of content.

10. A program causing a computer to function as:
a classification unit configured to classify pieces of content in a manner that each piece of content is arranged in a multi-dimensional space and actions of extracting two of the pieces of content and swapping the two pieces of content based on distances indicating similarity between each of the two extracted pieces of content and neighboring pieces of content which are located around the two pieces of content are repeated; and
a display control unit configured to control displaying of graphical user interfaces (GUIs) representing pieces of content located at a predetermined interval among the pieces of content classified by the classification unit.
